(19) United States
(12) Patent Application Publication
(10) Pub. No.: US 2015/0263468 A1
(43) Pub. Date: Sep. 17, 2015

(54) Electric Connector

(71) Applicant: Advanced-Connectek Inc., New Taipei City (TW)

(72) Inventors: Ching-Tien Chen, New Taipei City (TW); Shu-Lin Duan, Kunshan City (CN); Wei Wan, Kunshan City (CN); Fu-Yi Xu, Kunshan City (CN); Pei-Hsuan Huang, New Taipei City (TW)

(21) Appl. No.: 14/631,916

(22) Filed: Feb. 26, 2015

(30) Foreign Application Priority Data
Mar. 13, 2014 (CN) 201410090833.1

(51) Int. Cl. H01R 24/78

(52) U.S. Cl. CPC H01R 24/78

(57) ABSTRACT

An electric connector comprises an insulation body, a shielding shell, first and second conductive terminals, and a holding member. The insulation body has a base and a tongue blade extended horizontally forward from the base. The shielding shell encases the insulation body. Each first or second conductive terminal has an anchor section fixedly located in the insulation body, a contact section extended forward from the anchor section and located on the tongue blade, and a welding section bent upward from the anchor section and extended outside the base. The holding member located on the base has an elongate slot and apertures that run through the base up and down. The elongate slot allows the welding sections of the first conductive terminals to pass through and anchor therein. Each aperture allows the welding section of each second conductive terminal to pass through and anchor therein.

### BACKGROUND OF THE INVENTION

1. Field of the Invention

The present invention relates to an electric connector and particularly to an electric connector equipped with a holding member to allow welding sections of conductive terminals to pass through and anchor.

2. Description of the Prior Art

At present signal transmission standard of Universal Serial Bus (USB) has advanced from USB 1.0/2.0 to a faster speed USB 3.0. Electric connectors conformed to the USB 3.0 standard can form electric connection with other electric connectors that also conform to the USB 3.0 standard to do signal transmission according to the USB 3.0 standard. In addition, the electric connectors conformed to the USB 3.0 standard also can form electric connection with electric connectors conformed to USB 1.0/2.0 standard to do signal transmission according to the USB 1.0/2.0 standard. In order to make the electric connector conformed to the USB 3.0 standard compatible with the USB 3.0 and USB 1.0/2.0 standards, the electric connector should include at least one set of conductive terminals conformed to the USB 3.0 standard—for signal transmission—and another set of conductive terminals conformed to the USB 1.0/2.0 standard for signal transmission.

Please refer to FIGS. 1 and 2 for a conventional electric connector that conforms to the USB 3.0 standard. It includes an insulation body 1, a shielding shell 2, a plurality of first conductive terminals 3, a plurality of second conductive terminals 4 and a holding member 5. The first conductive terminals 3 are used to do signal transmission that conforms to the USB 3.0 standard, while the second conductive terminals 4 are used to do signal transmission that confirms to the USB 1.0/2.0 standard. The insulation body 1 has a base 11 and a tongue blade 12 extended horizontally forward from the base 11. The shielding shell 2 encases the insulation body 1. The shielding shell 2 and the tongue blade 12 of the insulation body 1 jointly form a coupling space 10 to house a coupling electric connector (not shown in the drawings). Each first conductive terminal 3 has an anchor section 31, a contact section 32 and a welding section 33. The anchor section 31 is fixedly located in the insulation body 1. The contact section 32 is extended forward from the anchor section 31 into the coupling space 10 and located on the tongue blade 12. The welding section 33 is bent upward from the anchor section 31 and extended outside the base 11 of the insulation body 1. Each second conductive terminal 4 also has an anchor section 41, a contact section 42 and a welding section 43. The anchor section 41 is fixedly located in the insulation body 1. The contact section 42 is extended forward from the anchor section 41 into the coupling space 10 and located on the tongue blade 12. The welding section 43 is bent upward from the anchor section 41 and extended outside the base 11. The holding member 5 is located on the base 11 of the insulation body 1, and has a plurality of apertures 5 run through the holding member 5 up and down. Each aperture 51 allows the welding section 33 and 43 of the first and second conductive terminals 3 and 4 to pass through respectively and anchor therein.

Although the apertures 51 of the holding member 5 and the first and welding sections 33 and 43 of the first and second conductive terminals 3 and 4 mate each other so that the welding sections 33 and 43 are rightly positioned in all directions such as front and rear, and left and right, the holding member 5 thus formed is complicated in structure and consumes a greater amount of plastic material, hence production efficiency is lower and the cost is higher. Moreover, for the conductive terminal to transmit high frequency signals, such as the first conductive terminal 3 that conforms to the USB 3.0 standard with a signal conductive terminal 3a, its welding section 33 is covered by a greater amount of plastic material on the circumference. This downgrades its high frequency characteristics.

### SUMMARY OF THE INVENTION

The present invention aims to provide an electric connector with a holding member formed in a simpler structure and consumed less material.

To achieve the foregoing object the electric connector of the invention includes an insulation body, a shielding shell, a plurality of first conductive terminals, a plurality of second conductive terminals and a holding member. The insulation body has a base and a tongue blade extended horizontally forwards from the base. The shielding shell encases the insulation body. The shielding shell and the tongue blade jointly form a coupling space to house a coupling electric connector. Each of the first conductive terminals and the second conductive terminals has an anchor section, a contact section and a welding section. The anchor section is fixedly located in the insulation body. The contact section is extended forward from the anchor section into the coupling space and located on the tongue blade. The welding section is bent upward from the anchor section and extended outside the base. The holding member is located on the base and has a first elongate slot and a plurality of first apertures. The first elongate slot and the first apertures run through the holding member up and down. The first elongate slot allows the welding sections of the first conductive terminals to pass through and anchor therein. Each first aperture allows the welding section of each second conductive terminal to pass through and anchor therein.

In one embodiment of the invention the first elongate slot has a front inner wall and a rear inner wall opposing the front inner wall. The front inner wall or the rear inner wall has a plurality of anchor ribs formed thereon, or both the front inner wall and the rear inner wall have respectively a plurality of anchor ribs formed thereon. In addition, the front inner wall or the rear inner wall has a plurality of troughs where no anchor ribs are formed. The troughs run through the holding member up and down.

In another embodiment of the invention the first elongate slot has a front inner wall and a rear inner wall opposing the front inner wall. The front inner wall or the rear inner wall has a plurality of troughs formed thereon, or both the front inner wall and the rear inner wall have respectively a plurality of troughs formed thereon. The troughs run through the holding member up and down.

In yet another embodiment of the invention the first conductive terminals include a plurality of signal conductive terminals and a ground conductive terminal. The first elongate slot is replaced by a plurality of T-shaped trenches and a second aperture. Each T-shaped trench has a second elongate slot and a notch communicating with the second elongate slot. Each second elongate slot, each notch and each second aperture run through the holding member up and down. Each T-shaped trench allows the welding section of each signal conductive terminal to run through and anchor therein. The second aperture allows the welding section of the ground conductive terminal to run through and anchor therein.

In yet another embodiment of the invention the holding member has a front wall and a rear wall opposing the front inner wall, and the T-shaped trenches and the second aperture are located in front of the first apertures. Each notch cuts through the front wall. Or the T-shaped trenches and the second aperture are located behind the first apertures, and the notch cuts through the rear wall.

By means of the technique set forth above, the electric connector of the invention allows the welding section of each of the first and second conductive terminals to be rightly positioned in all directions. The structure also is simpler and consumes less material, hence production efficiency increases and the cost is lower. In addition, the welding section of the first conductive terminals for high frequency signal transmission is covered by less plastic material on the circumference, hence can provide improved high frequency characteristics.

The foregoing, as well as additional objects, features and advantages of the invention will be more readily apparent from the following embodiments and detailed description, which proceed with reference to the accompanying drawings.

### BRIEF DESCRIPTION OF THE DRAWINGS

FIGS. 1 and 2 are a perspective view and an exploded view of a conventional electric connector conformed to USB 3.0 standard.

FIGS. 3 and 4 are a perspective view and an exploded view of a first embodiment of the electric connector of the invention.

FIGS. 5 and 6 are schematic views of other two embodiments of the holding member of the electric connector of the invention in the first embodiment.

FIGS. 7 and 8 are a perspective view and an exploded view of a second embodiment of the electric connector of the invention.

FIGS. 9 and 10 are a perspective view and an exploded view of a third embodiment of the electric connector of the invention.

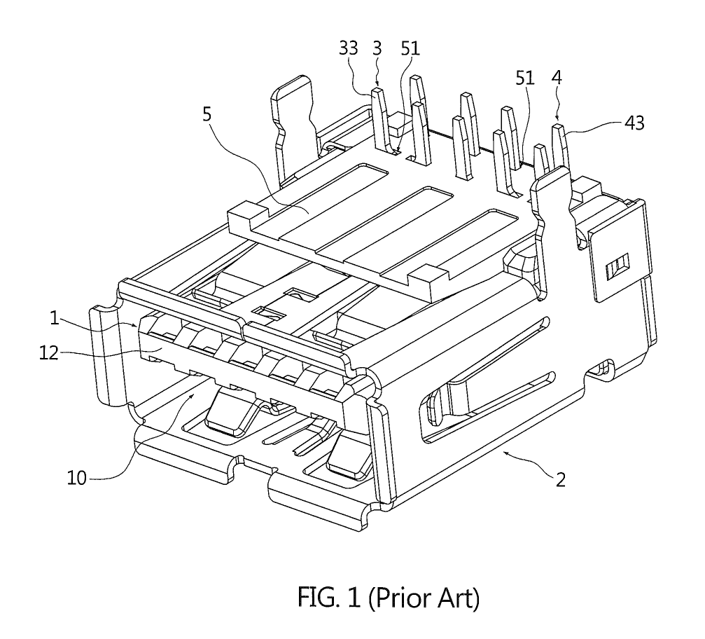

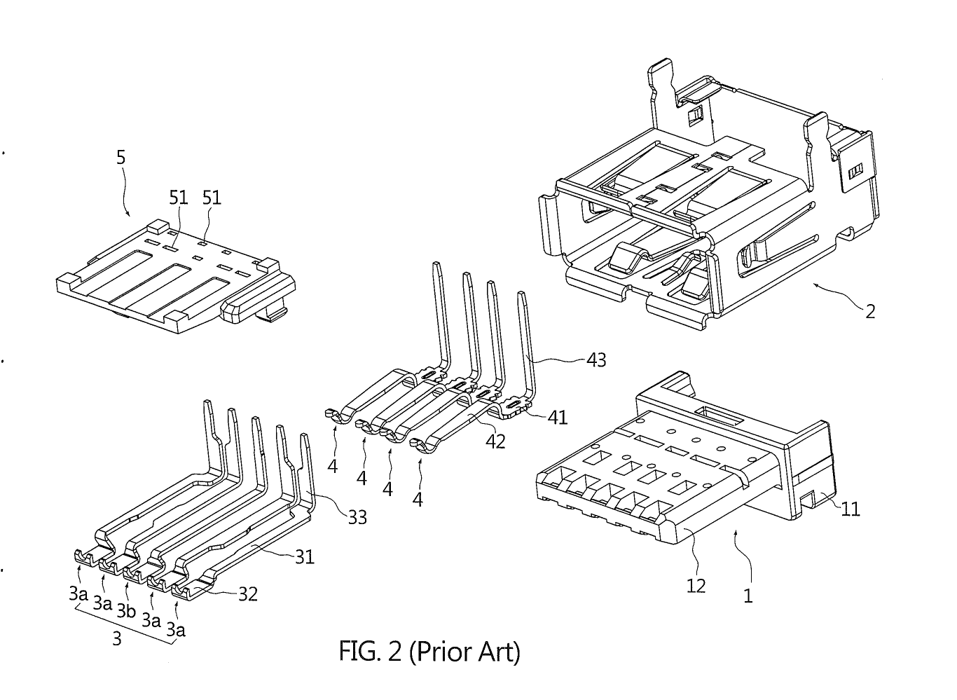

### DESCRIPTION OF THE PREFERRED EMBODIMENTS

In the following embodiments same or similar elements are marked by same or similar notations. Moreover, the terms of direction such as up, down, left, right, front and rear merely are based on the directions of the attached drawings from use perspective, and are not the limitation of the invention.

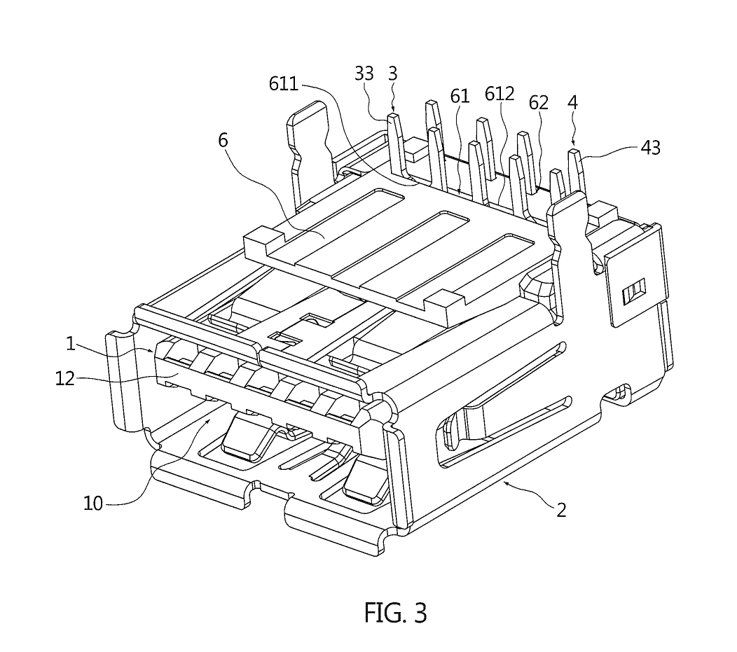

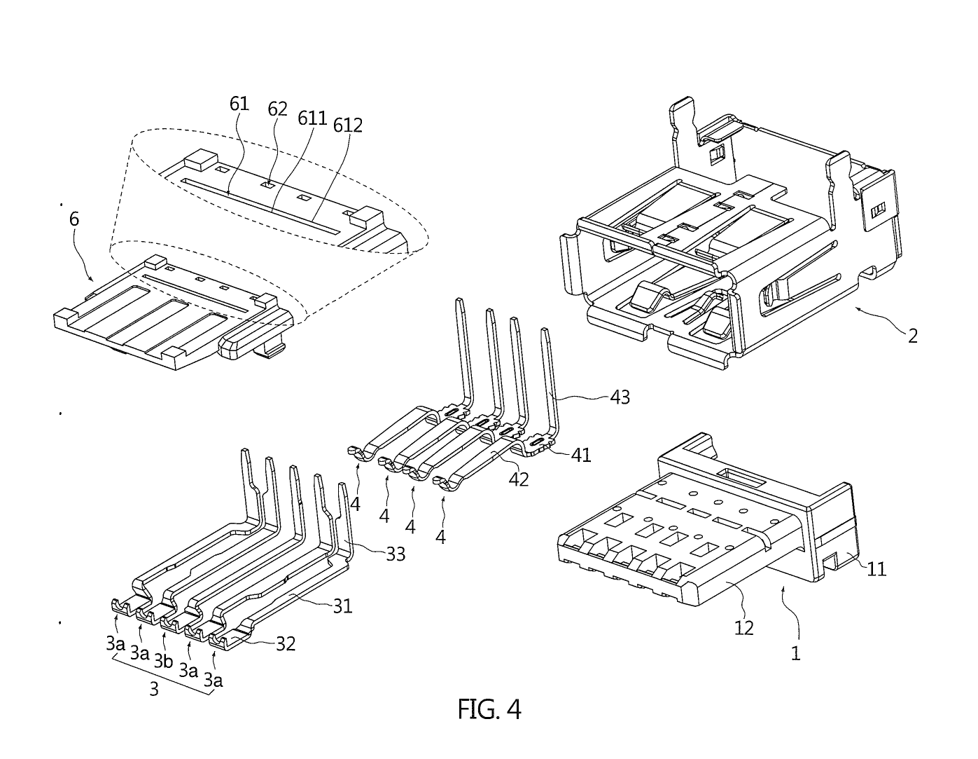

Please refer to FIGS. 3 and 4 for a first embodiment of the electric connector of the invention. The electric connector comprises an insulation body 1, a shielding shell 2, a plurality of first conductive terminals 3, a plurality of second conductive terminals 4 and a holding member 6. The electric connector can be one conforming to USB 3.0 standard as an example. The first conductive terminals 3 are used for signal transmission that confirms to USB 3.0 standard, while the second conductive terminals 4 are used for signal transmission that confirms to USB 1.0/2.0 standards. The insulation body 1 has a base 11 and a tongue blade 12 extended horizontally forwards from the base 11. The shielding shell 2 encases the insulation body 1. The shielding shell 2 and the tongue blade 12 jointly form a coupling space 10 to house a coupling electric connector (not shown in the drawings). Each first conductive terminal 3 has an anchor section 31, a contact section 32 and a welding section 33. The anchor section 31 is fixedly located in the insulation body 1. The contact section 32 is extended forward from the anchor section 31 into the coupling space 10 and located on the tongue blade 12. The welding section 33 is bent upward from the anchor section 31 and extended outside the base 11. Each second conductive terminal 4 has an anchor section 41, a contact section 42 and a welding section 43. The anchor section 41 is fixedly located in the insulation body 1. The contact section 42 is extended forward from the anchor section 41 into the coupling space 10 and located on the tongue blade 12. The welding section 43 is bent upward from the anchor section 41 and extended outside the base 11.

The holding member 6 is located on the base 11, and has a first elongate slot 61 and a plurality of first apertures 62 that run through respectively the holding member 6 up and down. The first elongate slot 61 allows the welding sections 33 of all the first conductive terminals 3 to pass through and anchor thereon. Each first aperture 62 allows the welding section 43 of one second conductive terminal 4 to pass through and anchor therein. The first elongate slot 61 has a front inner wall 611 and a rear inner wall 612 opposing the front inner wall 611. The front inner wall 611 and the rear inner wall 612 butt respectively the welding sections 33 of the first conductive terminals 3 to make sure that the welding sections 33 are rightly positioned in the front and rear directions. In addition, the front inner wall 611 or the rear inner wall 612 can have a plurality of anchor ribs (not shown in the drawings) formed thereon, or both the front inner wall 611 and the rear inner wall 612 can have a plurality of anchor ribs (not shown in the drawings) formed thereon to make sure that the welding sections 33 are rightly positioned in the left and right directions.

Through the first elongate slot 61 of the holding member 6 in the first embodiment the welding sections 33 of all the first conductive terminals 3 can run through and be rightly positioned in all directions such as front, rear, left and right. Such a structure is simpler and consumes less material, hence production efficiency is higher and the cost is lower. Furthermore, since the welding sections 33 of the first conductive terminals 3 for high frequency transmission are covered by less plastic material on the circumferences, they have improved high frequency characteristics. In addition, the holding member 6 also provides a plurality of the first apertures 62 to allow the welding sections 43 of the second conductive terminals 4 to pass through and position in a fit manner, hence the welding sections 43 also can be rightly positioned in all directions such as front, rear, left and right.

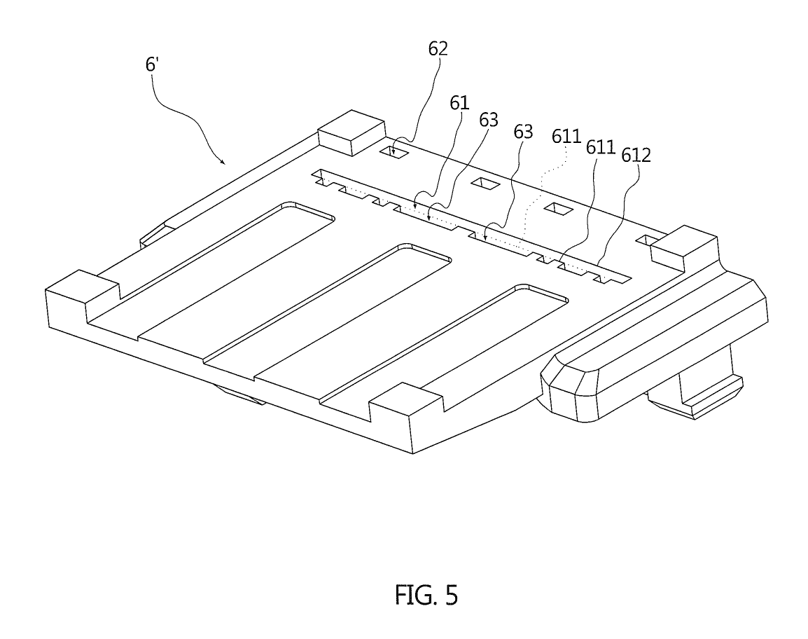

Please refer to FIG. 5 for another embodiment of the holding member used in the electric connector of the first embodiment. The holding member 6′ in this embodiment differs from the holding member 6 shown in FIG. 4 by forming a plurality of troughs 63 on the front inner wall 611 of the first elongate slot 61. Each trough 63 runs through the holding member 6′ up and down and is a slot with a tooth shape formed on a single side. Moreover, on the front inner wall 611 where no troughs 63 are formed a plurality of anchor ribs are formed thereon. On the contrary, the front inner wall 611 without the anchor ribs can have troughs 63 formed thereon. In this embodiment, because the holding member 6′ adopts the first elongate slot 61 and a plurality of troughs 63 to form a slot with a tooth shape formed on a single side, the working piece produced via injection molds in such a shape can further have enhanced strength.

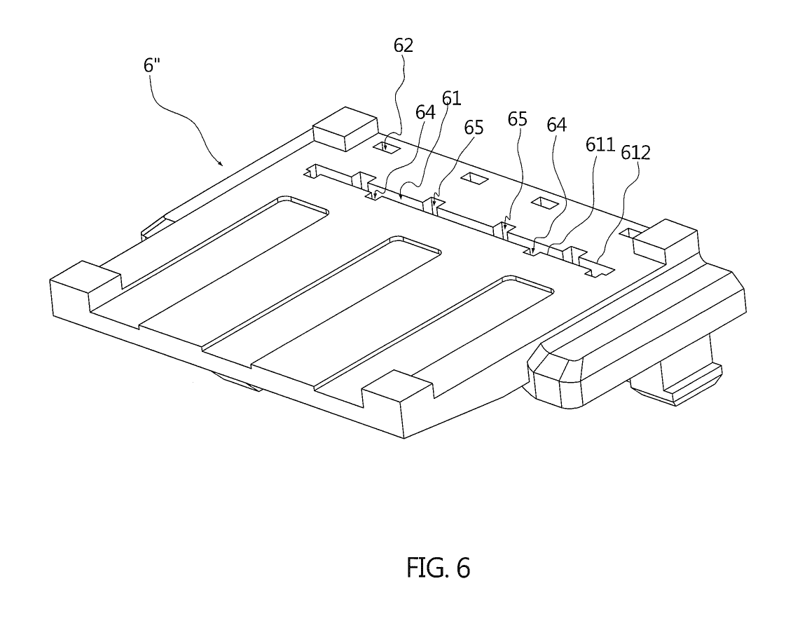

Please refer to FIG. 6 for yet another embodiment of the holding member used in the electric connector of the first embodiment. The holding member 6″ in this embodiment differs from the holding member 6 shown in FIG. 4 by forming a plurality of troughs 64 on the front inner wall 611 of the first elongate slot 61, and also forming a plurality of troughs 65 on the rear inner wall 612. Each of the troughs 64 and 65 runs through the holding member 6″ up and down and is a slot with a tooth shape formed on two sides. Moreover, on the front inner wall 611 where no troughs 64 are formed a plurality of anchor ribs are formed thereon. On the contrary, the front inner wall 611 without the anchor ribs can have troughs 64 formed thereon, and the rear inner wall 612 without the anchor ribs can also have troughs 65 formed thereon. In this embodiment, because the holding member 6″ adopts the first elongate slot 61 and a plurality of troughs 64 and 65 to form a slot with a tooth shape formed on two sides, the working piece produced via injection molds in such a shape can further have enhanced strength.

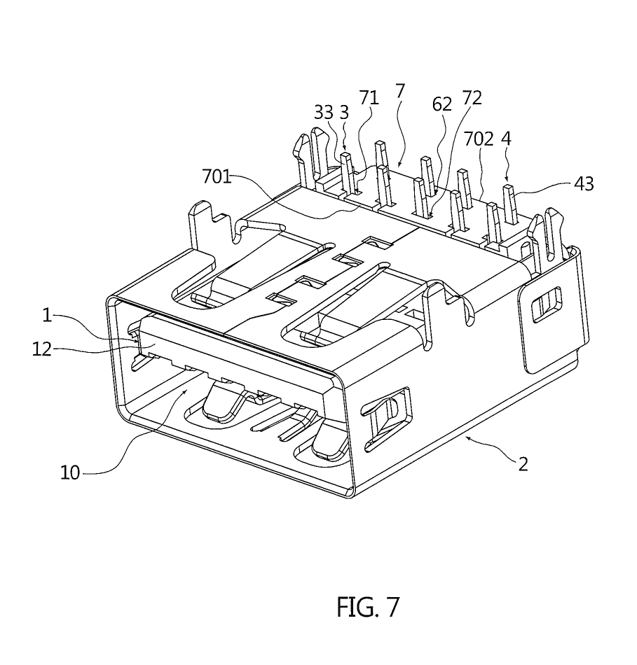

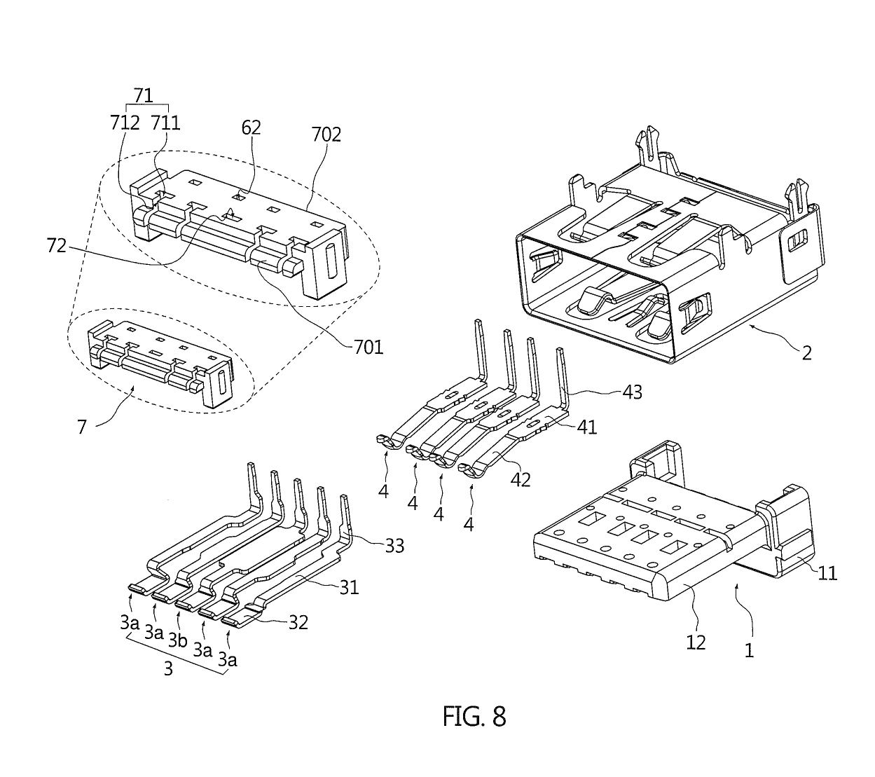

Please refer to FIGS. 7 and 8 for a second embodiment of the electric connector of the invention. It differs from the first embodiment shown in FIGS. 3 and 4 mainly on the holding member. A holding member 7 in this embodiment is formed by replacing the first elongate slot 61 of the holding member 6 in FIG. 4 by a plurality of T-shaped trenches 71 and a second aperture 72. Each T-shaped trench 71 has a second elongate slot 711 and a notch 712 communicating with the second elongate slot 711. Each second elongate slot 711, each notch 712 and the second aperture 72 run through respectively the holding member 7 up and down. Each T-shaped trench 71 allows the welding section 33 of each signal conductive terminal 3a of the first conductive terminals 3 to pass through and anchor therein, and the second aperture 72 allows the welding section 33 of the ground conductive terminal 3b to pass through and anchor therein. Moreover, each first aperture 62 allows the welding section 43 of each second conductive terminal 4 to pass through and anchor therein. The second elongate slot 711 of each T-shaped trench 71 and the welding section 33 of the signal conductor terminal 3a of each first conductive terminal 3 mate each other so that the welding section 33 of the signal conductor terminal 3a is rightly positioned in all directions such as front, rear, left and right. The notch 712 of each T-shaped trench 71 can reduce the plastic material used to cover the circumference of the signal conductive terminal 3a and also improve high frequency characteristics. The second aperture 72 and the welding section 33 of the ground conductive terminal 3b of the first conductive terminal 3 also mate each other so that the welding section 33 of the ground conductive terminal 3b also is rightly positioned in all directions such as front, rear, left and right.

In the second embodiment the welding section 33 of the first conductive terminal 3 is located in front of the welding section 43 of the second conductive terminal 4, hence the T-shaped trench 71 and the second aperture 72 of the holding member 7 are located in front of the first apertures 62. The holding member 7 has a front wall 701 and a rear wall 702 opposing the front wall 701, hence the notch 712 of the T-shaped trench 71 cuts through the front wall 701 of the holding member 7.

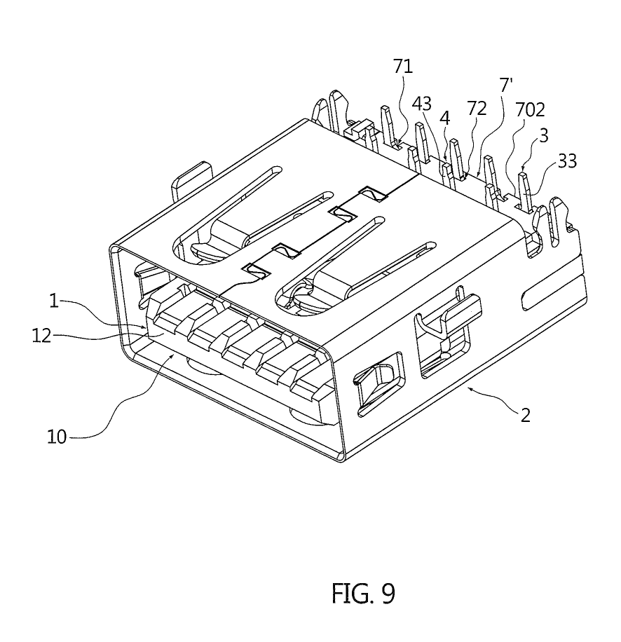

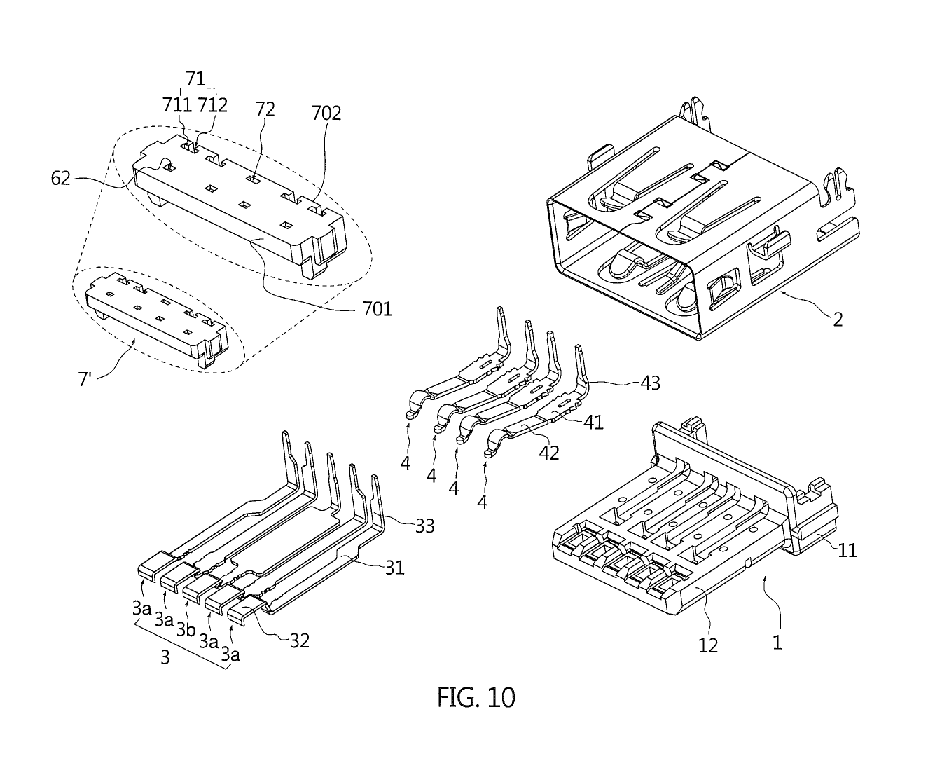

Please refer to FIGS. 9 and 10 for a third embodiment of the electric connector of the invention. It differs from the second embodiment shown in FIGS. 7 and 8 mainly on the locations of the welding sections of the first and second conductive terminals that result in different locations of the notch of the T-shaped trench and the cut through direction thereof. In the third embodiment the welding section 33 of each first conductive terminal 3 is located behind the welding section 43 of each second conductive terminal 4, hence the T-shaped trench 71 and the second aperture 72 of the holding member 7′ are located behind the first apertures 62. The holding member 7′ has a front wall 701 and a rear wall 702 opposing the front wall 701, hence the notch 712 of the T-shaped trench 71 cuts through the rear wall 702 of the holding member 7′.

While the preferred embodiments of the invention have been set forth for the purpose of disclosure, they are not the limitation of the invention, modifications of the disclosed embodiments of the invention as well as other embodiments thereof may occur to those skilled in the art. Accordingly, the appended claims are intended to cover all embodiments which do not depart from the spirit and scope of the invention.

I claim:

1. An electric connector, comprising:
an insulation body including a base and a tongue blade extended horizontally forward from the base;
a shielding shell to encase the insulation body and collaborate with the tongue blade to form a coupling space to house a coupling electric connector;
a plurality of first conductive terminals and second conductive terminals that have respectively an anchor section, a contact section and a welding section, the anchor section being fixedly located in the insulation body, the contact section being extended forward from the anchor section into the coupling space and located on the tongue blade, the welding section being bent upward from the anchor section and extended outside the base; and
a holding member which is located on the base and includes a first elongate slot and a plurality of first apertures, the first elongate slot and each first aperture running through the holding member up and down, the first elongate slot allowing the welding sections of the first conductive terminals to pass through and anchor therein, each first aperture allowing the welding section of one second conductive terminal to pass through and anchor therein.

2. The electric connector of claim 1, wherein the first elongate slot includes a front inner wall and a rear inner wall opposing the front inner wall, the front inner wall and/or the rear inner wall having a plurality of anchor ribs formed thereon.

3. The electric connector of claim 2, wherein the front inner wall or the rear inner wall where no anchor ribs are formed has a plurality of troughs formed thereon, each trough running through the holding member up and down.

4. The electric connector of claim 1, wherein the first elongate slot has a front inner wall and a rear inner wall opposing the front inner wall, the front inner wall and/or the rear inner wall having a plurality of troughs formed thereon, each trough running through the holding member up and down.

5. The electric connector of claim 1, wherein the first conductive terminals include a plurality of signal conductive terminals and a ground conductive terminal, the first elongate slot being replaced by a plurality of T-shaped trenches and a second aperture, each T-shaped trench having a second elongate slot and a notch communicating with the second elongate slot, each second elongate slot, each notch and the second aperture running through the holding member up and down, each T-shaped trench allowing the welding section of each signal conductive terminal to pass through and anchor therein, the second aperture allowing the welding section of the ground conductive terminal to pass through and anchor therein.

6. The electric connector of claim 5, wherein the holding member has a front wall and a rear wall opposing the front wall, the T-shaped trenches and the second aperture being located in front of the first apertures, each notch cutting through the front wall.

7. The electric connector of claim 5, wherein the holding member has a front wall and a rear wall opposing the front wall, the T-shaped trenches and the second aperture being located behind the first apertures, each notch cutting through the rear wall.
